(19) United States
(12) Patent Application Publication
(10) Pub. No.: US 2026/0195837 A1
(43) Pub. Date: Jul. 9, 2026

(54) Automated Preliminary Evaluation Of Prior Academic Credit

(71) Applicant: The University of Phoenix, Inc., Phoenix, AZ (US)

(72) Inventors: Arthur Dylan Robbins, Mesa, AZ (US); Devin M. Andrews, Gilbert, AZ (US); Vikki Nowak, Phoenix, AZ (US); Daniel Michael, Scottsdale, AZ (US); Vera Dinshaw Springett, Glenview, IL (US); Trent Holt, South Jordan, UT (US); Kartheek Godavarthi, Tempe, AZ (US); Abrarahmed Maniyar, Fremont, CA (US); Jessica Hutson, Phoenix, AZ (US); Hector Silva-Robles, Phoenix, AZ (US); Monish Venkata Naga Sai Nallamilli, Tempe, AZ (US); Phillip Blake, Gainesboro, TN (US)

(21) Appl. No.: 19/441,708

(22) Filed: Jan. 6, 2026

Related U.S. Application Data
(60) Provisional application No. 63/742,819, filed on Jan. 7, 2025.

(51) Int. Cl. G06Q 50/20

(52) U.S. Cl. CPC G06Q 50/2053

(57) ABSTRACT

A prospective student preliminary evaluation system receives a selection of one or more educational programs offered by a target institution and transcript data for a plurality of completed courses. The system generates preliminary evaluation data for one or more educational programs. Generating the preliminary evaluation data comprises, for each completed course, determining transfer eligibility and applying a generative model to generate the preliminary evaluation data for the particular educational program based on the transcript data and the transfer eligibility determinations for the plurality of completed courses. The preliminary evaluation data for a particular educational program specifies a set of completed courses that are eligible to be transferred to the particular educational program. The system then makes the preliminary evaluation data accessible to the user via a user interface.

### RELATED APPLICATION DATA AND CLAIM OF PRIORITY

This application claims the benefit of U.S. Provisional Application No. 63/742,819, entitled AUTOMATED EVALUATION OF PRIOR ACADEMIC CREDIT FOR POSSIBLE TRANSFER TO NEW INSTITUTION, filed Jan. 7, 2025, the contents of which are incorporated by reference for all purposes as if fully set forth herein.

### TECHNICAL FIELD

The present disclosure relates to an integrated decision support ecosystem for prospective students applying for enrollment in educational programs. More specifically, the disclosure relates to the integration of machine learning and generative artificial intelligence models into an automated system for educational program selection, preliminary evaluation of credit transfer, and recommendation engine.

### BACKGROUND

Prior art student customer relationship management (CRM) systems are designed to help educational institutions manage interactions with prospective and current students. These systems facilitate the enrollment process, from lead generation to application management and student retention. CRMs automate various aspects of the admission process, making it easier for institutions to track applications, manage communications, and follow up with prospective students. This can significantly reduce the time and effort required to process applications. CRMs provide a centralized platform for managing student information, including application status, enrollment trends, and financial aid details. This helps institutions maintain accurate records and make informed decisions.

Colleges, universities, and other academic institutions have undergone major transformations due to online universities, smartphones, and the World Wide Web. Students can pursue educational programs without relocating, making education in some form widely available. Educational programs include any structured set of courses and requirements. The term “educational program” can refer to a major, minor, concentration, degree, or certification, for example. Learning Management Systems (LMSs) deliver lectures, assignments, and grades online. Virtual classrooms enable live classrooms. E-books, recorded lectures, and interactive simulations provide a rich online learning experience. Students can access course materials, submit assignments, and join discussions via apps or websites.

While CRMs automate many aspects of application and enrollment for prospective students, many processes are still performed manually, such as guiding students to suitable academic programs and evaluating prior learning credits from other institutions. These processes can be time-consuming and require human expertise that is difficult to integrate into an automated process. For example, the process of transferring prior learning credits can vary by institution, but it is primarily a manual process. Some institutions have transcripts sent directly from the issuing institution during the enrollment process, when possible. Some institutions do not allow third parties to request official transcripts, in which case, the student must request them. The receiving institution reviews transcripts to determine course equivalencies, accreditation requirements, and grade requirements. Accepted credits are applied toward the student's selected educational program. The review may consider residency requirements, regional accreditation of the previous institution, course level, program compatibility, grade earned, and time limits for credit transfer. When the review is complete, the student receives a transfer credit report showing which courses were accepted and how they apply to a particular educational program.

Many prospective students who are transferring credits are undecided about the educational program they want to pursue. Many factors contribute to selecting an educational program, including how transferred credits will apply to each program, how long it will take to complete each program, and how much each program will cost. Prospective students have high expectations of speed and efficiency due to increased use of online tools and smartphone apps. When a student initiates an application process through a smartphone app but has to wait several weeks for a transfer credit report, the process can be unsatisfactory or disappointing. Therefore, there is a need for improved automated systems for educational program selection and credit transfer review to enable students to make informed decisions quickly.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 illustrates a prospective student preliminary evaluation system in accordance with an embodiment.

FIGS. 2A-2F depict example user interface screens for program selection in accordance with particular embodiments.

FIGS. 2G-2I depict example user interface screens for providing transcript information in accordance with particular embodiments.

FIG. 2J depicts an example user interface screen presenting a prospective student's document library in accordance with an embodiment.

FIGS. 2K-2M depict example user interface screens illustrating credit transfer preliminary evaluation results in accordance with particular embodiments.

FIG. 3 is a block diagram illustrating the generation of suggested educational programs using a machine learning model in accordance with an embodiment.

FIG. 4 is a block diagram illustrating the generation of suggested educational programs according to a user-selected path using prompt templates and a generative AI model in accordance with an embodiment.

FIG. 5 is a flowchart illustrating the operation of a prospective student preliminary evaluation system for managing credit transfer evaluation in accordance with an embodiment.

FIG. 6 is a block diagram illustrating the operation of a course mapping component of a prospective student preliminary evaluation system in accordance with an embodiment.

FIG. 7 is a block diagram illustrating the creation of a preliminary evaluation document in accordance with an embodiment.

FIG. 8 is a flowchart illustrating the operation of a prospective student preliminary evaluation system for matching courses from transcript data to courses in a target program in accordance with an embodiment.

FIG. 9 is a block diagram that illustrates a computer system upon which aspects of the illustrative embodiments may be implemented.

FIG. 10 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the embodiments. It will be apparent, however, that the embodiments may be practiced without these specific details. In other instances, well-known structures and devices are shown in block diagram form in order to avoid unnecessarily obscuring the embodiments.

### General Overview

The illustrative embodiments provide a prospective student preliminary evaluation system for guiding prospective students to relevant educational programs based on inputs entered by students through a user interface, machine learning (ML) and generative artificial intelligence (AI) models, and supporting data structures. In some embodiments, the prospective student preliminary evaluation system is integrated into a customer relationship management (CRM) system. The system enables educational program selection, transcript submission, credit transfer preliminary evaluation, and eventual application submission through a user interface, such as a smartphone app or website. The system provides an AI-generated and human-reviewed credit transfer preliminary evaluation via the user interface to assist users with program selection and, ultimately, application submission. Initially, every credit transfer preliminary evaluation is subject to human review. Future implementations may employ human review subject to guardrails and rely on fully AI-generated preliminary evaluations when practicable and allowed by governing bodies.

The illustrative embodiments combine user interface components, optical character recognition (OCR) and document parsing techniques, document storage management, and customer management systems to assist human evaluators and to provide prospective students with timely information to condense the program selection and, eventually, the admissions process. The illustrative embodiments compile a database of historical data that maps courses of source institutions to courses of the target institution. Each mapping of a source course to a target course has an associated confidence value indicating the likelihood that the source course's credits can be transferred to the target course. The system leverages this database of historical data, as well as similarity searches of course titles, analyses of course descriptions, and evaluations of policies and procedures, to generate a preliminary evaluation of credit transfer.

Ultimately, credit transfer decisions are made by human evaluators; however, the credit transfer preliminary evaluations can inform their decisions. Furthermore, preliminary evaluations can be provided to prospective students through the user interface as estimates of potential time and tuition savings for educational programs, enabling prospective students to make informed choices.

### Prospective Student Preliminary Evaluation System

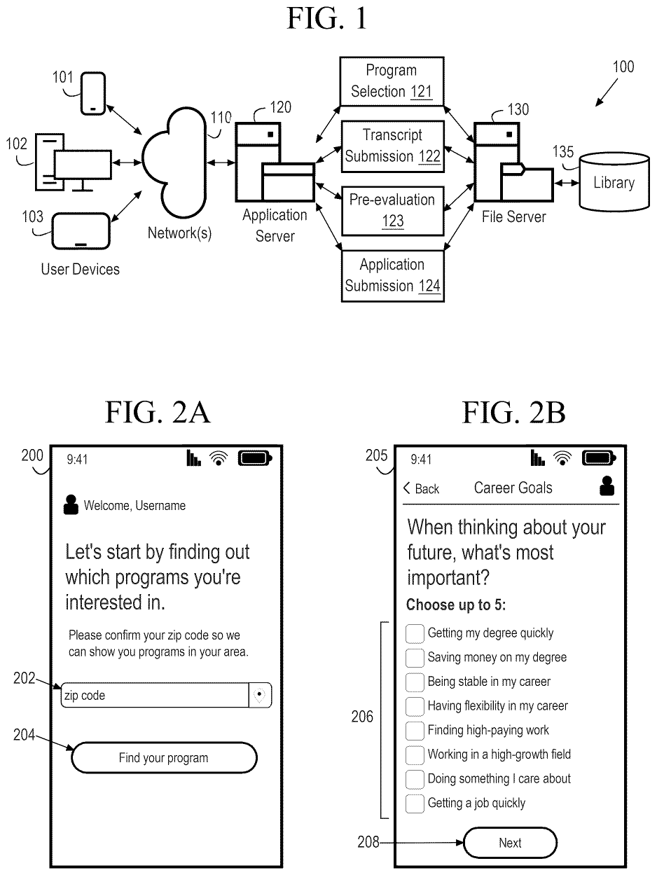

FIG. 1 illustrates a prospective student preliminary evaluation system 100 in accordance with an embodiment. Prospective students access the system 100 using a device associated with the user, such as a smartphone device 101, a personal computer 102, or a tablet device 103. The devices 101-103 include software for interacting with an application server 120 through network(s) 110. In some embodiments, the network(s) 110 includes the Internet and one or more local area networks (LANs), such as one or more wired or wireless networks. The application server 120 may be implemented as a single computing device, a server cluster, or a server instance in a cloud environment, or an edge-based content delivery and rendering layer.

In one embodiment, the software is an application or software app designed to interact with the application server 120. In another embodiment, the software is a web browser, and the student initiates a session with the application server 120 by entering a website address or uniform resource locator (URL) into the web browser. In some embodiments, each prospective student has an account with the application server 120 to track the student's enrollment progress. For example, the user may have an associated username and password that are used to establish a session with the application server 120.

The application server 120 and the software on the user devices 101-103 provide a user interface through which students make selections, enter data, upload files, and access data. The application server 120 provides the functions of program selection 121, transcript submission 122, preliminary evaluation of credit transfers 123, and application submission 124 via the user interface. To provide these functions, the application server 120 can store and access data structures, files, and metadata associated with a user's account in library storage 135 through file server 130. In some embodiments, the file server 130 is implemented as a database server, such a relational database management system (RDBMS).

Program selection 121 guides a prospective student through the user interface to select one or more educational programs of interest. In one embodiment, program selection 121 prompts the user to choose fields of study, desired degree levels, and/or areas of interest for major, minor, or concentration. In another embodiment, program selection 121 prompts the user to select one or more goals, such as earning a degree quickly, saving on tuition, working in a high-growth field, or following a passion. In another embodiment, program selection 121 prompts the user for a location, such as a zip code or residential address. Program selection 121 then provides recommendations of candidate programs that might be of interest to the student based on the user inputs. The user inputs may be quantitative, qualitative, or a combination of the two. For example, the user may select a goal of fastest path to a degree or even a goal of receiving a degree in three years. Alternatively, the user may select a goal of the best path to a degree, which is a qualitative determination.

In one embodiment, program selection 121 uses an ML model to suggest educational programs based on user inputs, e.g., location, goals, interests, and preferred fields of study. In one embodiment, the ML model is trained based on historical data of educational program selection by previous students. The ML model may access a course catalog that specifies a set of educational programs, including required courses, general education requirements, etc. In other embodiments, the ML model can access external data, such as employment statistics and wage growth data, based on the user's location. In one embodiment, the ML model is a generative AI model, such as a large language model (LLM), and program selection 121 generates a prompt based on the user inputs that instructs the generative AI model to suggest a predetermined number of educational programs.

In one embodiment, the user interface prompts the prospective student to choose a path for selecting a program. For example, a first path may be to choose a program based on field of study and degree level, a second path may be to choose a program based on goals (e.g., earn a degree quickly, save on tuition, have a stable career, work in a high-paying or high-growth field, pursue a passion, etc.), and a third path may be to select a program based on location, programs available in that location, jobs available in that location, and wage growth data in that location. The system then selects a prompt template for the chosen path and generates a prompt using the selected prompt and the user's inputs.

Transcription submission 122 enables the prospective student to upload or enter transcript information for previously earned credits to be transferred. In the embodiment, the system uses unofficial transcripts or copies of official transcripts for the preliminary evaluation. Official transcripts would be obtained once the student applies for admission in a program. A preliminary evaluation is an unofficial evaluation. The prospective student can upload multiple transcripts, as needed (i.e., when the student has attended multiple prior institutions). The user can interact with the user interface to upload a transcript as a document (e.g., a portable document format (PDF) document) or an image (e.g., a joint photographic experts group (JPEG or JPG) format image taken with a smartphone camera). Alternatively, the user can interact with the user interface to manually enter the transcript data. In some embodiments, the system persists partial progress for users who require multiple working sessions to complete the required information. For instance, the system may persist partial progress in the library storage 135. The system then processes the transcript data to extract course information, such as course identification (ID), course description, number of credits, grade, etc. Processing the transcript data may include parsing a document or performing optical character recognition (OCR) on uploaded documents or images. The system stores the transcript data in a document library associated with the user in library storage 135.

Preliminary evaluation 123 evaluates the transcript information to determine which prior learning credits are likely to be eligible for transfer and generates a preliminary evaluation report for each of the educational programs chosen by the prospective student. In some embodiments, the prospective student preliminary evaluation system 100 maintains a course catalog database (not shown) that stores the educational programs and courses provided by the target institution and a course mapping database (not shown) that maps courses offered by other institutions to courses provided by the target institution. For a given educational program, preliminary evaluation 123 determines whether each course in the transcript information is likely to be eligible for transfer into the given educational program as a required course, a general education course, or an elective based on the course catalog database, the course mapping database, and policies and procedures. Preliminary evaluation 123 then generates a preliminary evaluation report explaining required credits, transferred credits, remaining credits, and tuition savings based on the unofficial credit transfer preliminary evaluation result. The prospective student preliminary evaluation system 100 then stores the preliminary evaluation report for each of the educational programs chosen by the student in the document library storage associated with the prospective student and causes the preliminary evaluation reports to be accessible by the prospective student through the user interface.

As mentioned previously, credit transfer decisions are made by human evaluators. The system leverages a database of human-made evaluation decisions to train preliminary evaluation 123. A human evaluator can also oversee the recommendations generated by preliminary evaluation 123, with the human evaluator in the loop via guardrails. The prospective student preliminary evaluation system 100 informs the prospective student through the user interface that the preliminary evaluation reports are unofficial, that the credit transfer evaluation is an estimate, and that credit transfer cannot be guaranteed until the prospective student has applied to the institution and the institution has examined the official transcripts.

Application submission 124 enables the prospective student to apply for enrollment in a chosen educational program. In some embodiments, application submission 124 provides application forms through the user interface, with information extracted from the transcript pre-populated into the application. Application submission 124 can send the prospective student an application form to fill out by storing the form in the student's document library storage.

### User Interface

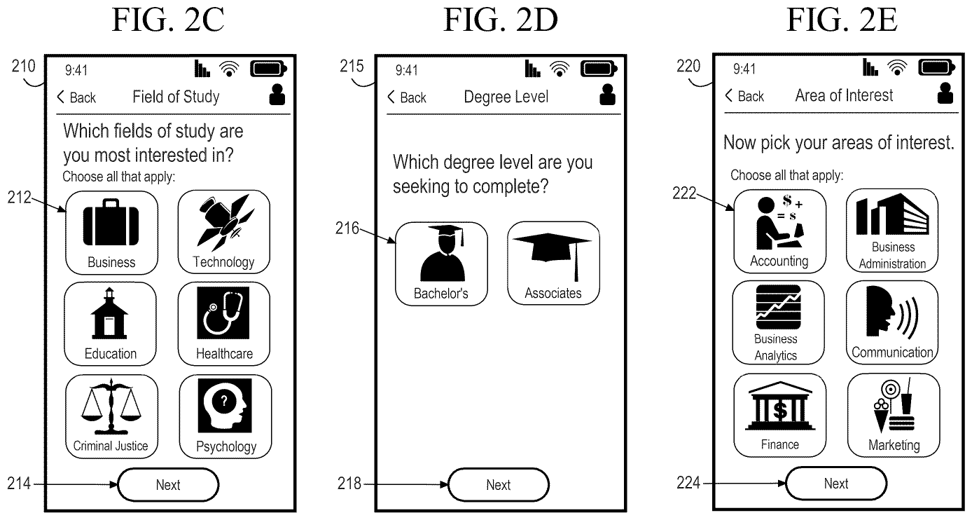

FIGS. 2A-2F depict example user interface screens for program selection in accordance with particular embodiments. The user interface components in the screens of the depicted examples are for illustrative purposes. The numbers and types of user interface screens and components are not intended to be limiting or exhaustive. Other types of user interface components can be used depending on the implementation.

FIG. 2A depicts an example user interface screen 200 that enables a prospective student to enter location information to select an educational program. In one embodiment, the user interface screen 200 is for a mobile app that can be displayed on a smartphone or tablet. The user interface screen 200 includes a zip code entry field 202 and a selectable button 204 that progresses to the next screen. In the depicted example, the user can enter a zip code into field 202; however, in other embodiments, the user can enter state, city, street address, etc. In an alternative embodiment, the user interface can prompt the user to allow access to location information obtained from the user's device, e.g., via a global positioning system (GPS) component of the user's device or from a network router or cellular communication towers.

There may be educational programs that are not available in certain areas. In the United States of America, universities must comply with state-specific regulations to offer programs, especially online programs, to residents of that state. Educational institutions may also focus on states with high demand for their programs. If a state has fewer prospective students for a particular program and strict requirements or high fees for authorization, the educational institution may not offer that program in that state. Furthermore, programs tied to professional licenses (e.g., nursing, teaching, or law) must meet state-specific standards. Expanding programs to new states requires marketing, compliance, and support infrastructure. Educational institutions weigh these costs against expected enrollment and revenue.

In some embodiments, the location is used to determine employment data, such as the number of job openings in certain fields, wage growth, and the like. The prospective student preliminary evaluation system can use this information to recommend educational programs based on the prospective student's location if allowed by governing bodies.

FIG. 2B depicts an example user interface screen 205 to enable the prospective student to select one or more goals. In the depicted example, the user interface screen 205 includes a set of user-selectable options 206 and a selectable button 208. In one embodiment, the user-selectable options 206 can be checkbox control elements, each of which can be selected or deselected. The user interface screen 205 prompts the user to choose up to five goals from a list of goals 206 and select the button 208 to advance to the next screen.

In some embodiments, the selected goals are used to identify educational programs that align with the student's goals. For example, if the student chooses “Saving money on my degree” and/or “Getting my degree quickly,” the number of potentially eligible transfer credits may weigh more heavily. On the other hand, if the student chooses “Finding high-paying work,” “Working in a high-growth field,” or “Getting a job quickly,” then employment data, such as the number of job openings in certain fields, wage growth, and related factors, may carry more weight.

FIG. 2C depicts an example user interface screen 210 to enable the prospective student to select one or more fields of study. In the depicted example, the user interface screen 210 includes a set of user-selectable options 212 and a selectable button 214. In one embodiment, the user-selectable options 212 are on/off buttons, each of which can be selected or deselected. In an alternative embodiment, the user-selectable options 212 can be checkbox control elements. The user interface screen 210 prompts the user to select all fields of study options 212 that apply, then select the button 214 to advance to the next screen.

In some embodiments, the selected fields of study are used to filter educational programs, eliminating those that are not likely to be of interest. In other embodiments, the selected fields of study are used to weigh educational programs that match the selected fields of study more heavily, without eliminating programs that do not match the selected fields of study exactly.

FIG. 2D depicts an example user interface screen 215 that enables the prospective student to select a degree level. In the depicted example, the user interface screen 215 includes a set of user-selectable options 216 and a selectable button 218. In one embodiment, the user-selectable options 216 are on/off buttons, each of which can be selected or deselected. In an alternative embodiment, the user-selectable options 216 can be checkbox control elements. The user interface screen 215 prompts the user to select one of the degree level options 216, then select the button 218 to advance to the next screen.

In some embodiments, the selected degree level is used to filter educational programs, eliminating those that do not match the selected degree level. In other embodiments, the selected degree level is used to weigh educational programs that match the selected degree level more heavily, without eliminating programs that do not match the selected degree level exactly.

FIG. 2E depicts an example user interface screen 220 that enables the prospective student to select one or more areas of interest. In the depicted example, the user interface screen 220 includes a set of user-selectable options 222 and a selectable button 224. In one embodiment, the user-selectable options 222 are on/off buttons, each of which can be selected or deselected. In an alternative embodiment, the user-selectable options 222 can be checkbox control elements. The user interface screen 220 prompts the user to select all applicable areas of interest, then select the button 224 to advance to the next screen.

In some embodiments, the selected areas of interest are used to filter educational programs, eliminating those that are not likely to be of interest. In other embodiments, the selected areas of interest are used to weigh educational programs that match the selected areas of interest more heavily, without eliminating programs that do not match the selected areas of interest exactly.

FIG. 2F depicts an example user interface screen 225 that presents a plurality of recommended educational programs for the prospective student to select. In the depicted example, the user interface screen 225 includes a plurality of user-selectable options, such as user interface control 226, and a selectable button 228. In the depicted example, the user-selectable options are on/off buttons, each of which can be selected or deselected. In an alternative embodiment, the user-selectable options can be checkbox control elements. The user interface screen 225 prompts the user to select up to three programs from the recommended options. FIG. 2F shows three recommended programs; however, there may be more. For example, the user interface screen 225 may be scrollable to show additional recommended options. Alternatively, the user interface screen 225 may include multiple pages of options. After selecting one or more educational programs via the user-selectable options, the prospective student selects button 228 to advance to the next screen.

FIGS. 2G-2I depict example user interface screens for providing transcript information in accordance with particular embodiments. FIG. 2G depicts an example user interface screen 230 that enables the prospective student to initiate entry of transcript information. User interface screen 230 instructs the prospective student to prepare transcripts for each prior educational institution the student attended and detailed course information, such as course names and IDs, dates of attendance, and grades received. When the user is prepared to begin entering transcript information, the user selects button 232 to advance to the next screen.

FIG. 2H depicts an example user interface screen 240 that enables the prospective student to upload a transcript to the system. In the depicted example, the user interface screen 240 includes a plurality of data entry fields 242, a selectable button 244 to upload a transcript document, a selectable button 246 to upload a photo of a transcript document, and a link 248 to enter transcript data manually. The prospective student uses data entry fields 242 to enter information associated with a transcript for prior learning, including a school name, school city and/or state, and program of study.

The prospective student selects button 244 to initiate uploading a transcript document to the system. For example, the prospective student can upload a transcript document from local storage on the user's device. Alternatively, the prospective student can link to a transcript document stored on a server or in the cloud. In the depicted example, the transcript document can be a portable document format (PDF) document. In one embodiment, the user interface screen 240 specifies a file size limit.

The prospective student selects button 246 to initiate uploading a photo of a transcript document. For example, the prospective student can upload a photo file, such as a joint photographic experts group (JPEG or JPG) file, from local storage on the user's device. Alternatively, the prospective student can link to a photo file stored on a server or in the cloud or can take a photograph of a document using a camera within the user's device. In one embodiment, the user interface screen 240 specifies a file size limit.

The prospective student selects link 248 to initiate entering transcript data manually. The prospective student may select link 248 in the event that a transcript is not available for uploading or to take a photo. Manual entry of transcript data is not required if a transcript can be uploaded as a document or photo file. For example, selecting link 248 can advance to a series of screens that include data entry fields for one or more courses completed at another institution. In one embodiment, the screens can include a screen for each institution, including data entry fields for institution name, start date, end date, and courses completed. For each course, there may be a screen that includes data entry fields for course title, course ID, grade achieved, and number of credits earned.

When all transcript data has been entered and/or uploaded to the system, the prospective student can submit the transcript data. FIG. 2I depicts an example user interface screen 250 that enables the prospective student to submit the transcript data to the prospective student preliminary evaluation system. In the depicted example, user interface screen 250 includes a selectable button 252 for submitting the request and a selectable button 254 for adding another transcript. If the prospective student selects button 254, then the user interface returns to screen 240 shown in FIG. 2H to enable the student to enter another transcript. The student selects button 252 to advance to the next screen.

In accordance with the illustrative embodiments, the prospective student preliminary evaluation system generates a preliminary evaluation, also referred to as a preliminary evaluation report, for each selected program. Generation of the preliminary evaluation reports is described in further detail below. The prospective student enrollment system stores metadata associated with the student that identifies the selected educational programs in the student's document library storage. The prospective student preliminary evaluation system also stores transcript data and preliminary evaluation reports in the document library storage. The system stores information, including sensitive personal information, in the student's document library storage in a secure manner, such as by encrypting the data and applying additional controls on access to and modification of the stored information.

In some embodiments, the system uses push notifications to notify the prospective student that preliminary evaluation reports are available in the student's document library storage. In other embodiments, the prospective student may receive automated simple message protocol (SMS), emails, voice calls, and voicemails that notify the student that preliminary evaluation reports are available. In one embodiment, each preliminary evaluation report is reviewed by a human evaluator prior to making the preliminary evaluation report accessible to the prospective student. Alternatively, the preliminary evaluation report can be made available in the user interface with a notification that the report is unofficial and only an estimate of credit transfer results. If the user decides to apply, then the desired program and transfer credits can be pre-filled in the application for admission into the program, saving time and effort. Having a preliminary evaluation report can potentially reduce the application process by days.

FIG. 2J depicts an example user interface screen presenting a prospective student's document library in accordance with an embodiment. In the depicted example, user interface screen 255 includes controls 256 that present and provide access to one or more selected programs, controls 257 that present and provide access to one or more submitted transcripts, and controls 258 that present and provide access to one or more preliminary evaluations. User interface screen 255 displays the metadata and files stored in library storage. In some embodiments, the user can access, update, delete, or add to the information in the library storage via controls 256-258.

FIGS. 2K-2M depict example user interface screens illustrating credit transfer preliminary evaluation results in accordance with particular embodiments. FIG. 2K depicts an example user interface display 260 that presents credit transfer preliminary evaluation results to the user. As shown in FIG. 2K, screen 260 notifies the prospective student that the preliminary evaluation results are only an estimate of prior transfer credits. As stated previously, credit transfer decisions are made by human evaluators, and credit transfer cannot be guaranteed until the prospective student has applied to the institution and the institution has examined the official transcripts.

User interface screen 260 includes one or more user interface components that present credit transfer preliminary evaluation results for corresponding educational programs. For example, user interface component 262 presents condensed preliminary evaluation results for a Bachelor of Science in AccountingDegree. A favorite control 264 enables the prospective student to select the educational program associated with component 262 as a favorite. An expand control 266 enables the prospective student to expand the preliminary evaluation results. Also, link 269 enables the user to view the full preliminary evaluation report. The user interface component 262 also includes an estimated tuition savings portion 268, which provides a preliminary estimate of tuition savings based on transfer credits.

FIG. 2L depicts an example user interface screen with expanded preliminary evaluation results. In the depicted example, the user interface screen 270 includes a user interface component 272 with expanded preliminary evaluation results for a Bachelor of Science in Business with a Marketing Certificate. The expanded preliminary evaluation result provides additional information about the educational program that was not included in the condensed results.

FIG. 2M depicts an example user interface screen that presents a full preliminary evaluation report. In the depicted example, the user interface screen 280 includes a user interface component 282 that presents a preliminary evaluation report, including an estimate of transfer credits for the Bachelor of Science in AccountingDegree. As shown in FIG. 2M, the user interface component 282 details the required credits for required or core courses, general education courses, electives, and total credits required. The user interface component 282 also details the estimate of credits that are eligible to be transferred into the educational program and the remaining credits in each of the above categories. For instance, for required or core courses in the Bachelor of Science in AccountingDegree, there are 51 required credits for required or core courses, 6 credits may be transferred in (according to the preliminary estimate), and 45 credits are remaining for completion.

In one embodiment, the user interface component 282 presents the preliminary evaluation results from a results data structure, such as a JavaScript Object Notation (JSON), extensible Markup Language (XML), or comma separated values (CSV) file. The user interface component 282 may also include a control for downloading the preliminary evaluation results and a control for printing the preliminary evaluation results. In some embodiments, the preliminary evaluation results may be downloaded or printed in a document format, such as a PDF document.

### Program Selection

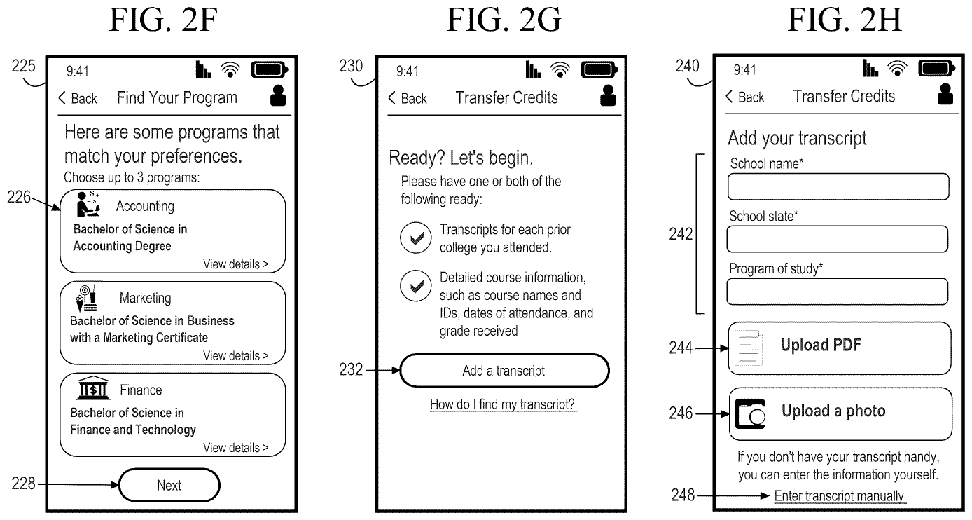

FIG. 3 is a block diagram illustrating the generation of suggested educational programs using a machine learning model in accordance with an embodiment. A prospective student enters features for selecting an educational program as described above with reference to FIGS. 2A-2E. The features may include, for example, a location, goals, interests, and fields of study. The program selection machine learning (ML) model 310 is trained to receive user-provided features and generate a set of suggested programs 315 based on a course catalog database 302 and an employment and job growth data storage 304. The program selection ML model 310 is trained on historical data from previous students' program selections.

The course catalog database 302 stores a catalog of educational programs and the courses that can be applied to the programs offered by the target institution. The course catalog database 302 stores course IDs, course names, course descriptions, start and end dates, credit hours, etc. For each program, the course catalog database 302 identifies which courses are required or core courses and which courses can be applied as general education credits.

The employment and job growth data storage 304 stores data that include employment statistics, job growth statistics, and demographic employment data. The employment statistics may consist of the number of people employed in a country, region, or industry; the percentage of the labor force that is unemployed or actively seeking work; the share of the population that is working or actively seeking work; the percentage of the working-age population that is employed; breakdowns of jobs by hours worked; and, employment levels by sector (e.g., healthcare, tech, manufacturing). The job growth statistics may include the number of new jobs added in a given period, which sectors are expanding or contracting, long-term forecasts for specific job roles, employment trends by state, city, or metro area, and changes in average earnings over time. The demographic employment data may include employment rates by education level.

In some embodiments, the program selection ML model 310 is a classification model, such as a logistic regression model, a decision tree model, a random forest model, a neural network, or the like. For example, the program selection ML model 310 may generate a yes/no classification for each educational program in the course catalog database 302. The program selection ML model 310 may also generate a confidence value for each educational program, representing the likelihood that the program should be suggested to the prospective student. The system may then identify the suggested programs 315 that have a confidence over a predetermined threshold. Alternatively, the system may rank the programs by confidence value and include a predetermined number of the top-ranked programs in the suggested programs 315.

In another embodiment, the program selection ML model is a generative AI model, such as a large language model (LLM). The system can generate a prompt for the generative AI model based on the user-provided features. In this embodiment, the system may populate a prompt template with the user-provided features. The prompt template may reference the course catalog database 302 and the employment and job growth data storage 304 and instruct the generative AI model to generate an output that lists the suggested programs 315.

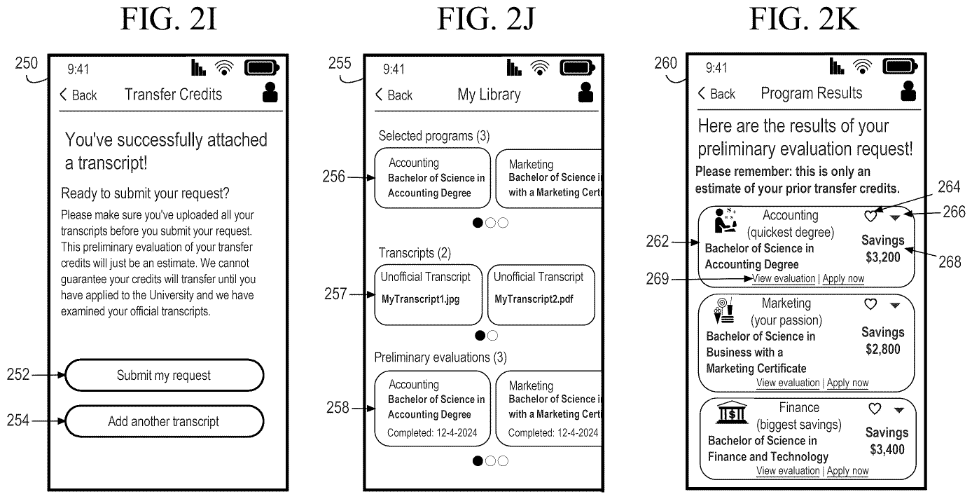

FIG. 4 is a block diagram illustrating the generation of suggested educational programs according to a user-selected path using prompt templates and a generative AI model in accordance with an embodiment. A prospective student 402 selects a path from a plurality of paths and enters features for selecting an educational program as user inputs via a user interface 410. The plurality of paths may include, for example:
Find a program based on location only.
Find a program based on a set of student goals.
Find a program based on interest.
Find a program based on fields of study and degree level.

A prompt engineering component 420 selects a prompt template from a set of prompt templates 425 based on the path selected by the user 402. There may be a corresponding prompt template for each path, each template having a context portion that can be populated with user inputs. One or more of the prompt templates may reference the course catalog database 302 and the employment and job growth data storage 304 and instruct the generative AI model 430 to generate an output that lists the suggested programs 435.

The prompt engineering component 420 then provides the generated prompt to the generative AI model 430, and the generative AI model generates an output that lists the suggested programs 435 based on the prompt.

### Credit Transfer Preliminary Evaluation

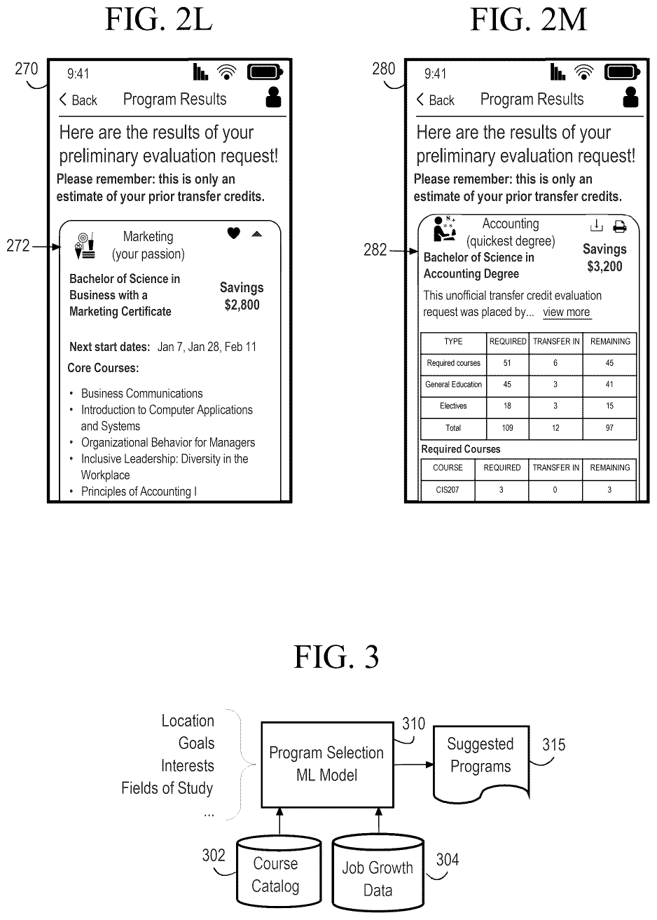

FIG. 5 is a flowchart illustrating the operation of a prospective student preliminary evaluation system for managing credit transfer evaluation in accordance with an embodiment. Operation begins with a preliminary evaluation submission for a particular educational program and a set of transcript data (block 500). The prospective student uses the system to upload documents to a document management system (block 501). These documents include transcript documents, such as PDFs or photographs of transcripts. The system then creates a preliminary evaluation record to track the status of the preliminary evaluation (block 502). The system then waits for a preliminary evaluation status update (block 503).

The system determines whether the status is complete or closed (block 504). In some embodiments, the status changes when a human evaluator closes the preliminary evaluation record or approves a preliminary evaluation result. If the status is not complete or closed (block 504: No), then the operation returns to block 503 to wait for a preliminary evaluation status update. If the status is complete (block 504: Complete), the system retrieves the preliminary evaluation document (block 505) and updates the preliminary evaluation record with a link to it (block 506). In some embodiments, the system gets a preliminary evaluation document that is generated by a machine learning model, such as a generative AI model. In some embodiments, a human evaluator reviews the preliminary evaluation document prior to marking the status as complete. In an alternative embodiment, a human evaluator creates the preliminary evaluation document with the assistance of AI tools.

Thereafter, or if the preliminary evaluation status is closed (block 504: Closed), the system updates the preliminary evaluation record with the case status and the completed date (block 507). Thereafter, the operation ends (block 508).

The preliminary evaluation process for credit transfer involves mapping courses offered by external institutions to those offered by the target institution. More specifically, for each course and target educational program, the mapping indicates a likelihood that the course will be eligible for transfer as a core course, a general-education course, or an elective in the target program. In accordance with some embodiments, the prospective student preliminary evaluation system provides a course mapping database that maps source courses offered by an external, third-party institution to target courses offered by the target institution.

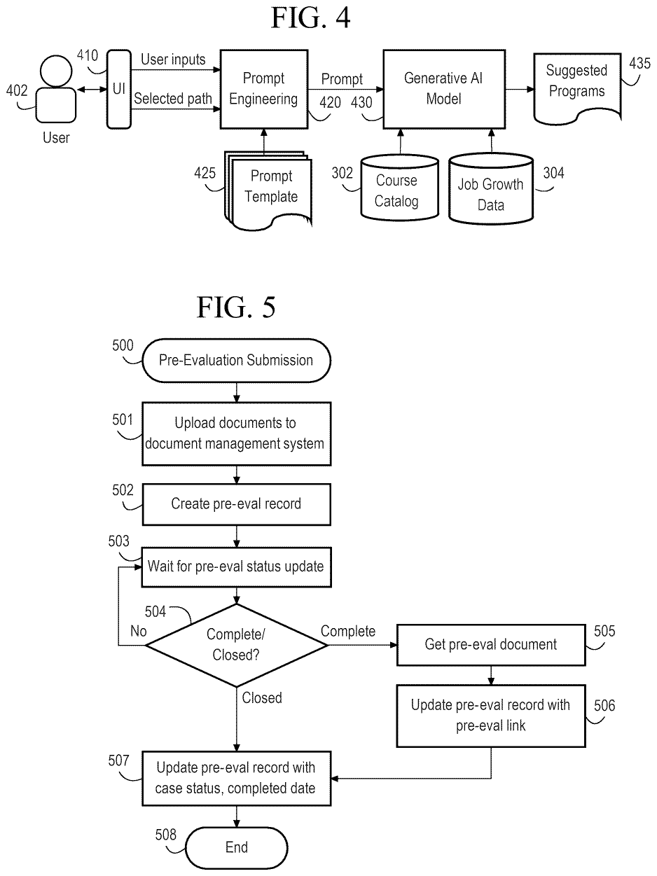

FIG. 6 is a block diagram illustrating the operation of a course mapping component of a prospective student preliminary evaluation system in accordance with an embodiment. The course mapping component 610 receives a database of third-party course catalogs 602 and a database of target courses 604. In one embodiment, the database of target courses 604 is the course catalog database 302 in FIG. 3 or 4.

The course mapping component 610 vectorizes or embeds the course data in a vector database (block 612). The mapping component 610 then performs a similarity search between the third-party courses and the target courses (block 614). The system determines the courses in third-party course catalogs 602 with the highest similarity to the target courses 604 (block 616). The system then adds the highest-similarity courses to the course mapping database 620 if they are not already in it (block 618).

In one embodiment, the system presents the highest-similarity courses to a human evaluator 605, who determines whether to add the mapping of the third-party course to a target course to the course mapping database 620.

In some embodiments, each mapping in the course mapping database 620 has an associated confidence value representing a likelihood that the course from the third-party course catalog will be eligible for transfer into a target program in the target courses 604. For example, the confidence value may be on a scale of 0 to 5, where a confidence value of 0 indicates that the course is not eligible for transfer and a confidence value of 5 indicates that the course is very likely transferable into the target program.

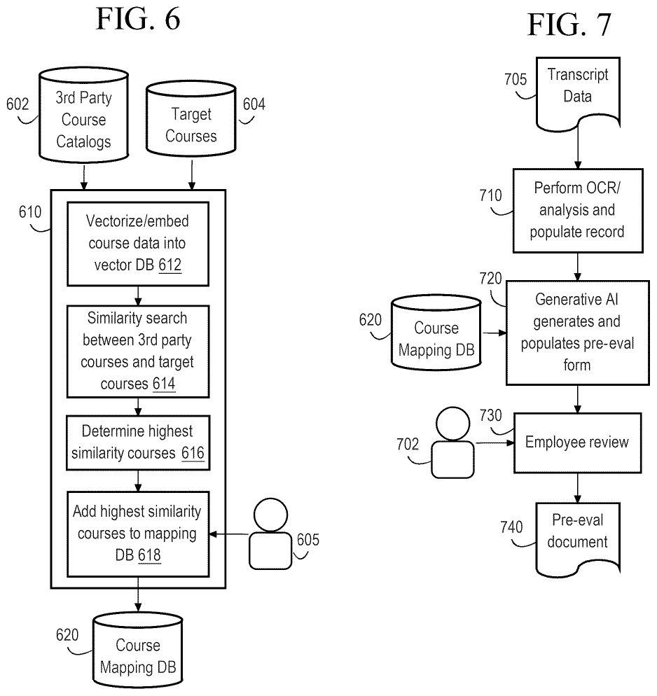

FIG. 7 is a block diagram illustrating the creation of a preliminary evaluation document in accordance with an embodiment. The system performs optical character recognition (OCR) or analysis on transcript data 705 and populates the preliminary evaluation record (block 710). A generative AI model generates and populates a preliminary evaluation form based on mappings in the course mapping database 620 (block 720). In one embodiment, the AI model selects a preliminary evaluation form from a set of forms. For example, there may be a different form for each educational program.

The system facilitates employee review by a human evaluator 702 (block 730). In one embodiment, the human evaluator 702 reviews the populated preliminary evaluation form and determines whether the appropriate results have been entered. If the human evaluator determines that results are incorrect, then the evaluator can reject the preliminary evaluation generated by the AI model and submit the case for manual evaluation. Therefore, in the illustrative embodiments, the human evaluator 702 manages the generative AI model to ensure it produces an acceptable result.

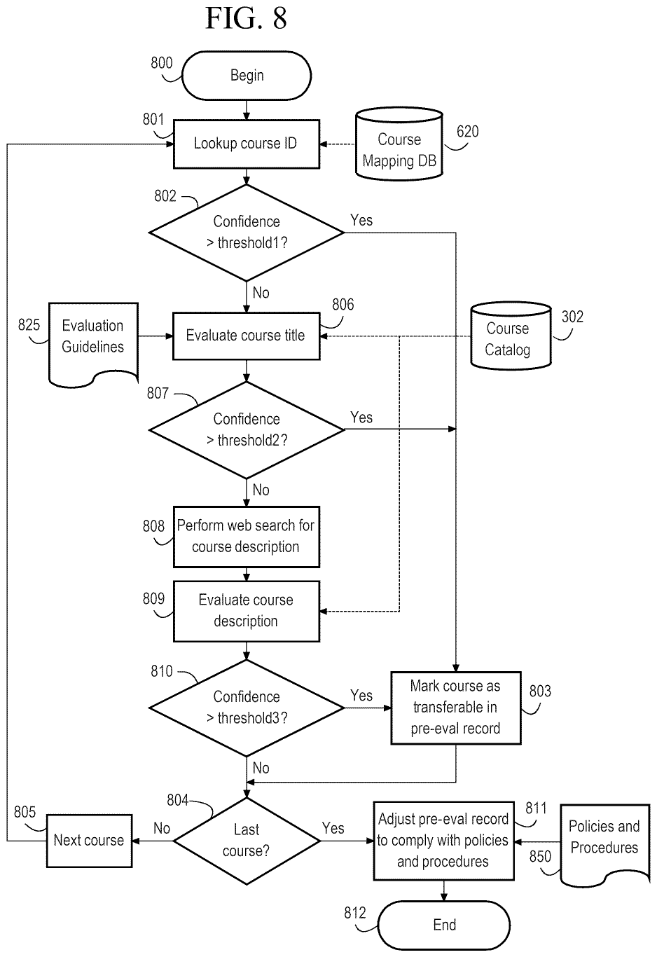

FIG. 8 is a flowchart illustrating the operation of a prospective student preliminary evaluation system for matching courses from transcript data to courses in a target program in accordance with an embodiment. Operation begins (block 800), and the system looks up a course identifier of a first course of the transcript data in the course mapping database 620 (block 801). As mentioned above, the course mapping database 620 may store a confidence value for each mapping. Thus, if the course ID appears in the course mapping database 620, the system determines whether the mapping's confidence value exceeds a first threshold (threshold1) (block 802).

If the confidence value is greater than the first threshold (block 802: Yes), then the system marks the course as transferable in the preliminary evaluation record (block 803). Then, the system determines whether the course is the last course to consider (block 804). If the course is not the last course (block 804: No), the system considers the next course in the transcript data (block 805), then returns to block 801 to look up the next course's course ID.

If there is no mapping for the course ID in the course mapping database 620, or if the confidence value is not greater than the first threshold (block 802: No), then the system evaluates the course title (block 806). In one embodiment, the system evaluates the course title by vectorizing or embedding the course title and performing a similarity search of the course title against the course titles in the course catalog database 302. The similarity search returns a similarity value indicating how closely the third-party course title matches a target course title in the course catalog database 302. The system generates a second confidence value based on the first confidence value from block 801, if one exists, and the similarity value. The system then determines whether the second confidence value is greater than a second threshold (threshold2) (block 807).

If the second confidence value is greater than the second threshold (block 807: Yes), then the system marks the course as transferable in the preliminary evaluation record (block 803). Then, the system determines whether the course is the last course to consider (block 804). If the course is not the last course (block 804: No), the system considers the next course in the transcript data (block 805), then returns to block 801 to look up the next course's course ID.

If the second confidence value is not greater than the second threshold (block 807: No), then the system performs a web search for a course description for the course (block 808). The system then evaluates the course description (block 809). In one embodiment, the system evaluates the course description by vectorizing or embedding the course description and performing a similarity search of the course description against the course descriptions in the course catalog database 302. The similarity search returns a similarity value indicating how closely the third-party course description matches a target course description in the course catalog database 302.

In another embodiment, the system evaluates the course description by populating a prompt template with the course description and providing the resulting prompt to a generative AI model, such as an LLM. The resulting prompt instructs the generative AI model to determine whether the course description matches one in the course catalog database 302 and generate a second similarity value representing a similarity between the third-party course description and the matching course description in the course catalog database 302.

The system generates a third confidence value based on the first confidence value from block 801, if one exists, the similarity value for the course title, and the similarity value for the course description. The system determines whether the third confidence value is greater than a third threshold (threshold3) (block 810). If the third confidence value is greater than the third threshold (block 810: Yes), then the system marks the course as transferable in the preliminary evaluation record (block 803). If the third confidence value is not greater than the third threshold (block 810: No), then the course is marked as not transferable. Then, the system determines whether the course is the last course to consider (block 804). If the course is not the last course (block 804: No), the system considers the next course in the transcript data (block 805), then returns to block 801 to look up the next course's course ID.

If the course is the last course in the transcript data (block 804: Yes), then the system adjusts the preliminary evaluation record to comply with policies and procedures 850 (block 811). For example, the system will consider the applicability of transfer credit to the program (e.g., grade earned, when the course was taken), regression, duplication, course waiver maximums, and so on. In one embodiment, the system adjusts the preliminary evaluation record by generating a prompt for a generative AI model that references the preliminary evaluation record and the policies and procedures 850 and instructs the generative AI model to determine if the preliminary evaluation violates any of the policies and procedures. The preliminary evaluation record can then be adjusted based on the results returned by the generative AI model. For example, the preliminary evaluation record and the results of the generative AI model can be provided to a human evaluator who adjusts the preliminary evaluation record. Thereafter, the operation ends (block 812).

### Program Selection Based on Preliminary Evaluation

In some embodiments, the prospective student preliminary evaluation system enables program selection based on a credit transfer preliminary evaluation. There may be cases where a prospective student has earned prior learning credits at another institution and is still unsure which programs are best. Returning to FIG. 3, the program selection ML model 310 can receive transcript data in addition to the other user inputs. The program selection ML model 310 can also access the course mapping database 620 of FIG. 6 and generate a list of suggested programs 315 based on which courses in the transcript data are likely to be transferred into which programs in the course mapping database.

In one embodiment, the program selection ML model 310 is a generative AI model, such as an LLM. The system may provide a prompt template that references the course catalog database 302, the employment and job growth data storage 304, and the course mapping database 620 and instructs the generative AI model to generate the list of suggested programs 315 based on tuition savings and/or time to completion of the educational programs given how likely the previously earned credits will be eligible for transfer. The system then populates the template with the user inputs (e.g., location, goals, interests) and the transcript data. The generative AI model can then generate the list of suggested programs 315 based on how the previously earned credits might apply to the educational programs offered by the target institution without the prospective student having to select a field of study or degree level.

In some embodiments, the system can then perform a more thorough preliminary evaluation process, as described above with reference to FIGS. 5-8. While the course mapping database 620 can provide some information about which earned course credits might be applied to a given program, the preliminary evaluation offers a more accurate determination of which credits can be transferred. However, the preliminary evaluation is still unofficial, and a human evaluator will review the preliminary evaluation result before a preliminary evaluation report is presented to the prospective student, before the prospective student initiates an application, or before the application is processed. Thus, a human evaluator can consult the preliminary evaluation results when making credit transfer decisions, but a human evaluator ultimately makes the final decision.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

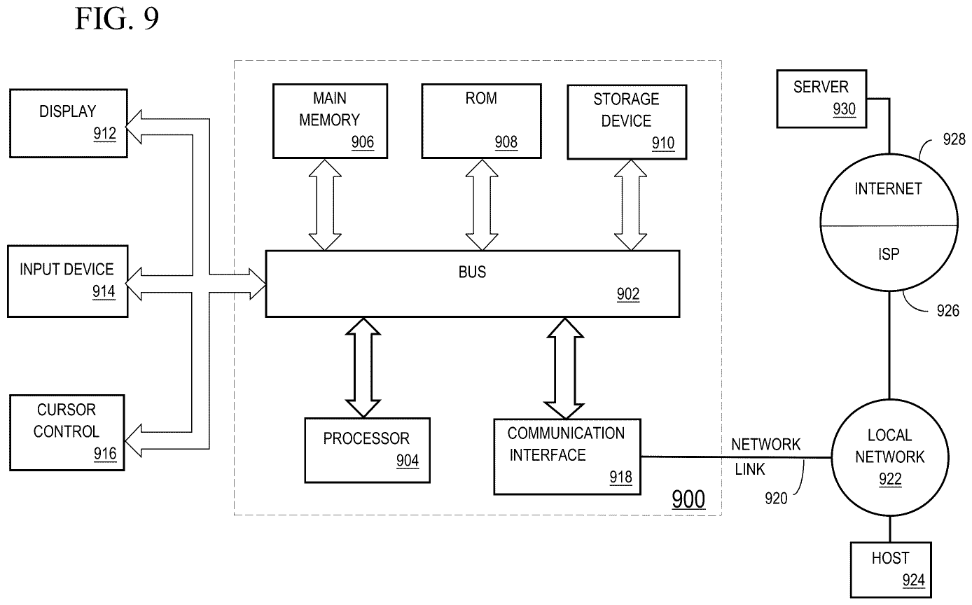

For example, FIG. 9 is a block diagram that illustrates a computer system 900 upon which aspects of the illustrative embodiments may be implemented. Computer system 900 includes a bus 902 or other communication mechanism for communicating information, and a hardware processor 904 coupled with bus 902 for processing information. Hardware processor 904 may be, for example, a general-purpose microprocessor.

Computer system 900 also includes a main memory 906, such as a random-access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal, and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world-wide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Over View

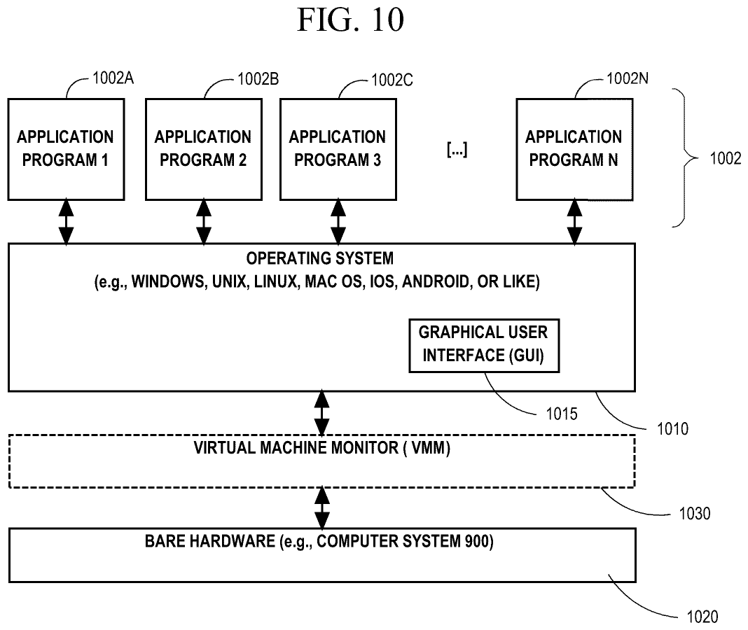

FIG. 10 is a block diagram of a basic software system 1000 that may be employed for controlling the operation of computer system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computer system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 900 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Large Language Models (LLMs)

In some illustrative embodiments, the mechanisms of the illustrative embodiments include or work in conjunction with Large Language Models (LLMs). LLMs are a class of artificial intelligence (AI) systems that employ deep learning architectures, such as transformer-based neural networks, to model and generate human-like natural language. These models are capable of understanding, processing, and generating textual content with high fluency and contextual relevance. Exemplary instances of such models include ChatGPT developed by OpenAI and Gemini (previously known as “Bard”) developed by Google LLC.

At their core, LLMs are statistical models trained on large-scale collections of unstructured natural language text. During training, the LLM is presented with sequences of tokens (typically representing words or sub-words) from these collections, or “corpora”, and learns to predict the probability distribution of the next token in the sequence, given the preceding context. This predictive modeling approach allows the LLM to learn syntactic structures, semantic relationships, contextual dependencies, and pragmatic cues present in natural language. The result is a system capable of performing a wide range of language-related tasks, including but not limited to, language modeling, text generation, machine translation, summarization, question answering, sentiment analysis, classification, and information retrieval.

The architecture of a typical LLM is built upon a deep neural network composed of multiple layers of self-attention and feedforward transformations, such as in a transformer architecture which uses a self-attention mechanism to process sequential data, such as text or audio in parallel rather than sequentially like a recurrent neural network (RNN). Each layer consists of multiple attention heads, layer normalization components, and residual connections. These components facilitate the model's ability to process and retain long-range dependencies across a text input. The model encodes input text as high-dimensional embeddings and transforms these embeddings through successive non-linear operations to derive context-aware representations, which ultimately inform the generation of output tokens.

As mentioned above, training an LLM requires exposure to a vast dataset of unstructured text, which may include web pages, books, articles, code repositories, and other publicly or commercially available sources. The training process typically involves unsupervised or self-supervised learning, wherein the model minimizes a loss function that penalizes inaccurate predictions of masked or subsequent tokens. Gradient-based optimization techniques, such as stochastic gradient descent (SGD) or the like, are employed to update the millions of model parameters over many iterations.

Once trained, an LLM is deployed for performing inference operations. As noted above, LLMs operate primarily in an autoregressive manner in that they are given an input sequence, and the LLM predicts the next most probable token in the sequence. The model then iteratively repeats this process, generating sequences of output tokens based on the evolving context. The input provided to the LLM is often referred to as a “prompt” and there is an entire area of study, referred to as “prompt engineering”, directed to the creation of appropriate prompts to obtain the best results from an LLM.

The LLM may be accessed through an interface or Application Programming Interface (API) that allows users to interact with the LLM via such prompts. The prompts themselves are a structured input string comprising one or more portions including an instructional portion, contextual portion, and operational portion. The instructional portion provides a natural language description of the task to be performed by the model. For example, “Translate the following paragraph into English” or “Summarize the main points of this document.” The contextual portion specifies the data or content upon which the task is to be executed, e.g., a body of text, a hyperlink to an online resource, a filename, a structured dataset, or the like. The data may be passed directly or indirectly, such as by referencing an external storage location.

An optional operational portion may be provided in the prompt to the LLM. The operational portion specifies software tools or executable utilities that the LLM is permitted or instructed to invoke when performing the requested task as specified in the instructional portion. Such tools can include functions for mathematical computation, database access, image processing, code execution, or custom analytics workflows. These tools may operate as discrete programs or callable APIs, and their output may be integrated into the LLM's processing pipeline to generate the response to the prompt.

In some cases, LLM prompts may further include formatting or template cues, few-shot examples, and special tokens or modifiers. The formatting or template cues may specify formatting constraints or delimiters to influence the structure of the output, e.g., “the output should be in JSON format”, use of bullet points, provide Extensible Markup Language (XML) tags. The few-shot examples may provide input-output pairs that serve as in-context demonstrations for the LLM to learn from within the prompt itself (also referred to as “few-shot learning”). The special tokens or modifiers may represent roles, commands, or model behaviors that the LLM is to exhibit.

When a prompt is input to a LLM, the prompt is first tokenized, i.e., transformed into a sequence of tokens using a tokenizer specific to the LLM's vocabulary. These tokens are then input into the LLM's embedding layers and processed sequentially via multi-headed self-attention mechanisms distributed across multiple transformer layers. The LLM generates its output token-by-token, with each subsequent token generated based on both the prompt and all previously generated tokens. This process allows the LLM to complete sentences, perform logical inference, or generate structured data, depending on the original prompt.

The LLM's internal representations are heavily influenced by the prompt's wording, token length, semantic specificity, and syntactic structure. Thus, small changes to a prompt, such as reordering phrases, changing tense, or altering punctuation, can yield significantly different outputs, underscoring the need for precise prompt engineering in production settings.

Inference in LLMs often involves probabilistic sampling from a learned distribution, which may be controlled via parameters such as temperature, top-k, or top-p (nucleus sampling). These mechanisms influence the diversity and determinism of the LLM's outputs. Advanced LLM implementations may further incorporate memory modules, retrieval augmentation (e.g., RAG models), multi-modal processing capabilities (e.g., combining text with images or audio), or system-level orchestration that allows for multi-agent collaboration or tool-assisted reasoning. Additionally, guardrails and alignment techniques may be applied to constrain the model's outputs to predefined safety or ethical guidelines.

The combination of scalable deep learning, prompt-based interaction, and extensible tool use makes LLMs a flexible platform for general-purpose AI applications across various domains such as education, law, healthcare, programming, and customer service.

### Prompt Engineering

As noted above, an important area of study in modern AI systems involving the use of LLMs is the area of prompt engineering since the output of an LLM is highly influenced by the particular content and configuration of the prompt that is input to it. Prompt engineering is a systematic process for designing and structuring input prompts in order to elicit desired behavior or output from a LLM. As the behavior of LLMs is highly dependent on the phrasing, structure, and context of the input prompt, prompt engineering involves strategic manipulation of prompts to achieve predictable and optimized outputs. Importantly, prompt engineering does not require retraining or fine-tuning of the underlying model(s) of the LLM. Instead, prompt engineering leverages the inherent capabilities of pretrained models by modifying the natural language or token-based instructions provided to the model so as to direct the model behavior in a desired direction.

The term “prompt” refers to the complete input provided to the LLM to induce the LLM to generate a particular output. Prompts can vary in structure depending on the task, with example elements of a prompt having been described previously.

Prompt engineering generally comprises a multi-step iterative process, including task definition, prompt design, prompt testing, evaluation and optimization, prompt finalization, and prompt versioning and adaptation. With the task definition step, the specific behavior or output required from the LLM is identified, e.g., classification, code generation, legal summarization, etc. In the prompt design step, an initial prompt is constructed that coveys the task and context, which may require careful selection of natural language phrasing, formatting requirements, and providing of examples and constraints for the LLM task being requested. The prompt testing step involves providing the constructed prompt to the LLM and observing the results generated by the LLM. The evaluation and optimization step, which may be performed iteratively with the prompt design and prompt testing steps, involves assessing the output against desired criteria, e.g., accuracy, completeness, tone, etc., and refining the prompt accordingly. The prompt finalization step involves locking in a prompt configuration for production use, such as storage in a prompt repository or otherwise made available for reuse, or integration into downstream applications. The optional prompt versioning and adaptation step involves maintaining multiple versions of prompts adapted for different models, user intents, or performance trade-offs.

Prompt engineering is an important enabling technique in various domains, including conversational agents and chatbots, legal, medical, or technical summarization, structured data extraction, automated code generation and debugging, AI-assisted creativity tools (e.g., story or image generation), and decision support systems. Prompt engineering enables these applications to be implemented without additional training data, thereby reducing development costs and enabling rapid prototyping.

### Cloud Computing

The term “cloud computing” is generally used herein to describe a computing model that enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from a user device associated with a user via a user interface, a selection of one or more educational programs offered by a target institution;
receiving, from the user device via the user interface, transcript data for one or more transcripts of a plurality of completed courses;
generating preliminary evaluation data for a particular educational program of the one or more educational programs, wherein:
generating the preliminary evaluation data comprises:
for each completed course in the plurality of completed courses, generating a transfer eligibility determination based on a course catalog database of the target institution and a course mapping database that maps courses provided by one or more source institutions to courses provided by the target institution; and
applying a generative model to generate the preliminary evaluation data for the particular educational program based on the transcript data and the transfer eligibility determinations for the plurality of completed courses, and
the preliminary evaluation data for the particular educational program specifies a set of completed courses of the plurality of completed courses that are eligible to be transferred to the particular educational program; and
causing the preliminary evaluation data to be accessible to the user via the user interface,
wherein the method is performed by one or more computing devices.

2. The method of claim 1, wherein generating a transfer eligibility determination for a particular completed course comprises:
looking up the particular completed course in the course mapping database, wherein a mapping of the particular completed course to a course catalog database of the target institution has an associated first confidence value; and
in response to determining that the first confidence value satisfies a first threshold criterion, determining that the particular completed course is eligible to be transferred to the particular educational program.

3. The method of claim 2, wherein generating a transfer eligibility determination for a particular completed course comprises:
in response to determining that the first confidence value does not satisfy the first threshold criterion, performing a similarity search of a title of the particular completed course and course titles of courses in the course catalog database of the target institution, wherein the similarity search generates a first similarity value;
determining a second confidence value based on one or more of the first confidence value or the first similarity value; and
in response to determining that the second confidence value satisfies a second threshold criterion, determining that the particular completed course is eligible to be transferred to the particular educational program.

4. The method of claim 3, wherein generating a transfer eligibility determination for a particular completed course comprises:
in response to determining that the second confidence value does not satisfy the second threshold criterion, applying a machine learning model to compare a course description of the particular completed course and course descriptions of courses in the course catalog database of the target institution, wherein the machine learning model generates a second similarity value;
determining a third confidence value based on one or more of the first confidence value, the first similarity value, or the second similarity value; and
in response to determining that the third confidence value satisfies a third threshold criterion, determining that the particular completed course is eligible to be transferred to the particular educational program.

5. The method of claim 1, further comprising storing at least one of the selection of the one or more educational programs, the transcript data, or the preliminary evaluation data in a library storage associated with the user.

6. The method of claim 5, further comprising causing contents of the library storage to be accessible to the user via the user interface.

7. The method of claim 1, wherein the preliminary evaluation data of the particular educational program indicates resource savings based on the set of completed courses that are eligible to be transferred to the particular educational program.

8. The method of claim 1, wherein receiving the selection of one or more educational programs comprises:
receiving, from the user device via the user interface, outcome data including one or more of:
at least one field of study,
a degree level,
at least one area of interest, or
at least one goal; and
providing the outcome data and the transcript data as input to a machine learning model; and
generating, by the machine learning model, a set of candidate educational programs based on the outcome data and the transcript data.

9. The method of claim 1, wherein receiving the selection of one or more educational programs comprises:
receiving, from the user device via the user interface, geographic location data associated with the user; and
providing the geographic location data as input to a machine learning model; and
generating, by the machine learning model, a set of candidate educational programs based on the geographic location data and employment and job growth data associated with the geographic location data.

10. The method of claim 1, wherein the preliminary evaluation data for the particular educational program indicates required credits, potential transfer credits completed, and a number of credits remaining to complete.

11. The method of claim 1, wherein the preliminary evaluation data for the particular educational program indicates at least one of:
required courses of study,
general education requirements,
elective requirements, or
proficiency requirements.

12. The method of claim 1, wherein receiving the transcript data comprises:
receiving an upload of one or more transcript files for a particular transcript; and
scanning the one or more transcript files for the transcript data for the particular transcript.

13. The method of claim 12, wherein:
the one or more transcript files comprise one or more image files, and
receiving the transcript data further comprises performing optical character recognition on the one or more image files to extract the transcript data.

14. The method of claim 1, further comprising:
receiving, from the user device via the user interface, a selection of the particular educational program from the one or more educational programs;
initiating an application for the particular educational program; and
initiating a transfer of credits in the application for the set of completed courses of the plurality of completed courses that are eligible to be transferred to the particular educational program.

15. A method comprising:
receiving, from a user device associated with a user via a user interface, transcript data for one or more transcripts of a plurality of completed courses;
generating preliminary evaluation data for one or more educational programs based on the transcript data, wherein the preliminary evaluation data for a particular educational program of the one or more educational programs specifies a set of completed courses of the plurality of completed courses that are eligible to be transferred to the particular educational program; and
causing the preliminary evaluation data to be accessible to the user via the user interface,
wherein the method is performed by one or more computing devices.

16. One or more non-transitory storage media storing instructions which, when executed by one or more computing devices, cause:
receiving, from a user device associated with a user via a user interface, a selection of one or more educational programs offered by a target institution;
receiving, from the user device via the user interface, transcript data for one or more transcripts of a plurality of completed courses;
generating preliminary evaluation data for a particular educational program of the one or more educational programs, wherein:
generating the preliminary evaluation data comprises:
for each completed course in the plurality of completed courses, generating a transfer eligibility determination based on a course catalog database of the target institution and a course mapping database that maps courses provided by one or more source institutions to courses provided by the target institution; and
applying a generative model to generate the preliminary evaluation data for the particular educational program based on the transcript data and the transfer eligibility determinations for the plurality of completed courses, and
the preliminary evaluation data for the particular educational program specifies a set of completed courses of the plurality of completed courses that are eligible to be transferred to the particular educational program; and
causing the preliminary evaluation data to be accessible to the user via the user interface.

17. The one or more non-transitory storage media of claim 16, wherein generating a transfer eligibility determination for a particular completed course comprises:
looking up the particular completed course in the course mapping database, wherein a mapping of the particular completed course to a course catalog database of the target institution has an associated first confidence value; and
in response to determining that the first confidence value satisfies a first threshold criterion, determining that the particular completed course is eligible to be transferred to the particular educational program.

18. The one or more non-transitory storage media of claim 17, wherein generating a transfer eligibility determination for a particular completed course comprises:
in response to determining that the first confidence value does not satisfy the first threshold criterion, performing a similarity search of a title of the particular completed course and course titles of courses in the course catalog database of the target institution, wherein the similarity search generates a first similarity value;
determining a second confidence value based on one or more of the first confidence value or the first similarity value; and
in response to determining that the second confidence value satisfies a second threshold criterion, determining that the particular completed course is eligible to be transferred to the particular educational program.

19. The one or more non-transitory storage media of claim 18, wherein generating a transfer eligibility determination for a particular completed course comprises:
in response to determining that the second confidence value does not satisfy the second threshold criterion, applying a machine learning model to compare a course description of the particular completed course and course descriptions of courses in the course catalog database of the target institution, wherein the machine learning model generates a second similarity value;
determining a third confidence value based on one or more of the first confidence value, the first similarity value, or the second similarity value; and
in response to determining that the third confidence value satisfies a third threshold criterion, determining that the particular completed course is eligible to be transferred to the particular educational program.

20. The one or more non-transitory storage media of claim 16, wherein receiving the transcript data comprises:
receiving an upload of one or more transcript files for a particular transcript; and
scanning the one or more transcript files for the transcript data for the particular transcript.
